(19) United States
(12) Patent Application Publication
(10) Pub. No.: US 2026/0149475 A1
(43) Pub. Date: May 28, 2026

(54) SYSTEMS AND METHODS FOR GENERATING DIGITAL PRE-DISTORTION (DPD) WITH COMPONENT-WISE AMPLITUDE UPPER BOUNDED COEFFICIENTS

(71) Applicant: Samsung Electronics Co., Ltd., Suwon-si (KR)

(72) Inventors: Sanjay Karmakar, Houston, TX (US); Wan Jong Kim, Tustin, CA (US); Pranav Dayal, San Diego, CA (US)

(21) Appl. No.: 19/323,940

(22) Filed: Sep. 9, 2025

Related U.S. Application Data
(60) Provisional application No. 63/723,809, filed on Nov. 22, 2024.

(51) Int. Cl. H04B 1/04

(52) U.S. Cl. CPC H04B 1/0475; H04B 2001/0425

(57) ABSTRACT

Provided are a system and a method for generating digital pre-distortion (DPD). The method includes receiving, by a processing circuit of a user equipment (UE), a first signal, receiving, by the processing circuit, a second signal generated based on an output of a power amplifier of the UE, performing, by the processing circuit, a modified least-squares operation based on the first signal and the second signal to generate a set of DPD coefficients, the performing of the modified least-squares operation including performing one or more operations on the first signal and the second signal, such that amplitudes of the set of DPD coefficients satisfy an amplitude upper bound, generating a third signal based on the set of DPD coefficients, and transmitting the third signal from the processing circuit.

### CROSS-REFERENCE TO RELATED APPLICATION(S)

This application claims priority to, and benefit of, U.S. Provisional Application Ser. No. 63/723,809, filed on Nov. 22, 2024, entitled “LOW COMPLEXITY DPD TRAINING WITH COMPONENT-WISE AMPLITUDE UPPER BOUND ON ITS COEFFICIENTS,” the entire content of which is incorporated herein by reference.

### FIELD

Aspects of some embodiments of the present disclosure relate to systems and methods for generating digital pre-distortion for communications.

### BACKGROUND

In the field of communications, a system may include one or more user equipment (UE), or user equipments (UEs), and a network node (e.g., a base station, such as a gNodeB (gNB)). The UEs may include a receiver and/or a transmitter (e.g., a transceiver) and a power amplifier (PA). The power amplifier may be used to amplify signals for transmitting a signal from a given UE to the network node. The power amplifier may introduce various non-linear distortions to the signals. A distorted signal can cause interference with other UEs and/or can cause signal recovery error (e.g., at the network node). To reduce such negative effects resulting from the non-linear distortions, a digital pre-distorter may be used in a UE to introduce non-linear distortions (e.g., digital pre-distortion (DPD)) to the signals before the signals are amplified by the power amplifier, such that the non-linear distortions introduced by the digital pre-distorter cancel out with the non-linear distortions introduced by the power amplifier.

In some systems, methods for generating DPD may involve complex computations (e.g., matrix inversion) and may result in overflow of DPD coefficient-storing registers in a memory of the UE, based on computed DPD coefficients having sizes that exceed the size of their designated memory registers.

The above information disclosed in this Background section is for enhancement of understanding of the background of the present disclosure, and therefore, it may contain information that does not constitute prior art.

### SUMMARY

Aspects of embodiments of the present disclosure are directed to systems and methods for performing communications and may provide improvements to generating pre-distortion.

According to some embodiments of the present disclosure, there is provided a method for generating digital pre-distortion (DPD), the method including receiving, by a processing circuit of a user equipment (UE), a first signal, receiving, by the processing circuit, a second signal generated based on an output of a power amplifier of the UE, performing, by the processing circuit, a modified least-squares operation based on the first signal and the second signal to generate a set of DPD coefficients, the performing of the modified least-squares operation including performing one or more operations on the first signal and the second signal, such that amplitudes of the set of DPD coefficients satisfy an amplitude upper bound, generating a third signal based on the set of DPD coefficients, and transmitting the third signal from the processing circuit.

The method may further include receiving, by the power amplifier of the UE, the third signal, and performing, by the power amplifier of the UE, amplification of the third signal to generate a fourth signal, and transmitting the fourth signal from the UE.

The amplitude upper bound may be associated with a bit-width of a unit of memory associated with storing the set of DPD coefficients.

The method may further include saving bits representing all of the DPD coefficients of the set of DPD coefficients in a first memory location allocated for storing the DPD coefficients, without any of the bits overflowing to a second memory location.

The method may further include performing an initial ordinary least-squares procedure to generate initial DPD coefficients, wherein the performing of the modified least-squares operation further includes iteratively scaling one or more of the initial DPD coefficients that exceed the amplitude upper bound.

The performing of the modified least-squares operation may further include determining a largest coefficient among initial coefficients obtained from an initial ordinary least-squares procedure.

The performing of the modified least-squares operation may further include iteratively scaling initial coefficients, obtained from an initial ordinary least-squares procedure, that exceed the amplitude upper bound relative to a size of a largest coefficient among the initial coefficients.

The performing of the modified least-squares operation may further include performing a simplified matrix inversion operation.

According to some other embodiments of the present disclosure, there is provided a system for generating DPD, the system including a processing circuit configured to receive a first signal and a second signal, the second signal being generated based on an output of a power amplifier, perform a modified least-squares operation based on the first signal and the second signal to generate a set of DPD coefficients, the performing of the modified least-squares operation including performing one or more operations on the first signal and the second signal, such that amplitudes of the set of DPD coefficients satisfy an amplitude upper bound, generate a third signal based on the set of DPD coefficients, and transmit the third signal from an interface of the processing circuit.

The power amplifier may be configured to receive the third signal, and amplify the third signal to generate a fourth signal.

The amplitude upper bound may be associated with a bit-width of a unit of memory associated with storing the set of DPD coefficients.

The processing circuit may be configured to perform saving bits representing all of the DPD coefficients of the set of DPD coefficients in a first memory location allocated for storing the DPD coefficients, without any of the bits overflowing to a second memory location.

The processing circuit may be configured to perform an initial ordinary least-squares procedure to generate initial DPD coefficients, wherein the performing of the modified least-squares operation further includes iteratively scaling one or more of the initial DPD coefficients that exceed the amplitude upper bound.

The performing of the modified least-squares operation may further include determining a largest coefficient among initial coefficients obtained from an initial ordinary least-squares procedure.

The performing of the modified least-squares operation may further include iteratively scaling initial coefficients, obtained from an initial ordinary least-squares procedure, that exceed the amplitude upper bound relative to a size of a largest coefficient among the initial coefficients.

The performing of the modified least-squares operation may further include performing a simplified matrix inversion operation.

According to some other embodiments of the present disclosure, there is provided a device for generating DPD, the device including a processing circuit, and a memory storing instructions, which, based on being executed by the processing circuit, cause the processing circuit to receive a first signal and a second signal, the second signal being generated based on an output of a power amplifier, perform a modified least-squares operation based on the first signal and the second signal to generate a set of DPD coefficients, the performing of the modified least-squares operation including performing one or more operations on the first signal and the second signal, such that amplitudes of the set of DPD coefficients satisfy an amplitude upper bound, generate a third signal based on the set of DPD coefficients, and transmit the third signal from the processing circuit.

The power amplifier may be configured to receive the third signal, and amplify the third signal to generate a fourth signal.

The instructions, based on being executed by the processing circuit, may cause the processing circuit to perform an initial ordinary least-squares procedure to generate initial DPD coefficients, wherein the performing of the modified least-squares operation further includes iteratively scaling one or more of the initial DPD coefficients that exceed the amplitude upper bound.

The performing of the modified least-squares operation may further include determining a largest coefficient among initial coefficients of obtained from an initial ordinary least-squares procedure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1A is a block diagram depicting a system including a UE and a network node for performing communications associated with the UE generating DPD, according to some embodiments of the present disclosure.

FIG. 1B is a block diagram depicting components of the UE and associated signals, according to some embodiments of the present disclosure.

FIG. 2A and FIG. 2B are diagrams depicting an example of DPD coefficients of an unconstrained DPD signal compared to an example of a second signal (e.g., a constrained DPD signal), the second signal/constrained DPD signal being generated according to some embodiments of the present disclosure.

FIG. 3A is a flowchart depicting example operations of a method for generating DPD, including a collection of samples, according to some embodiments of the present disclosure.

FIG. 3B is a block diagram depicting additional components/operations of the UE and associated signals, according to some embodiments of the present disclosure.

FIG. 3C is a flowchart depicting further mathematical details of some of the example operations of the method of FIG. 3A, according to some embodiments of the present disclosure.

FIG. 3D is a flowchart depicting additional operations of the method of FIG. 3A, including amplitude-bounded DPD coefficient computations and simplified matrix computations, according to some embodiments of the present disclosure.

FIG. 3E is a flowchart depicting further details of some of the example operations of FIG. 3D, according to some embodiments of the present disclosure.

FIG. 4 is a flowchart depicting an overview of example operations of a method for generating DPD, according to some embodiments of the present disclosure.

FIG. 5 is a block diagram of an electronic device in a network environment, according to some embodiments of the present disclosure.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of communications, a system may include one or more UEs and a network node (e.g., base station, such as a gNB). A given UE may be any suitable electronic device that is capable of transmitting and receiving wireless communications. For example, a given UE may be a mobile device such as a mobile phone (e.g., a cell phone or a smart phone), a tablet, a computer, a vehicle, and/or the like. The UEs may include a receiver and/or a transmitter (e.g., a transceiver) and a power amplifier (PA). The power amplifier may be used to amplify signals before transmitting a signal, from a given UE to the network node. The power amplifier may introduce various non-linear distortions to the signals, such as widening of signal spectrum causing degradation of adjacent channel leakage ratio (ACLR). A distorted signal can cause interference with other UEs and/or may cause signal recovery error at the network node.

To reduce such negative effects resulting from the non-linear distortions, a digital pre-distorter (e.g., a signal processing block/circuit) may be used as a compensator for PA non-linearity. For example, a digital pre-distorter may be used in a UE to introduce non-linear distortions (e.g., digital pre-distortion (DPD)) to the signals before the signals are amplified by the power amplifier, such that the non-linear distortions introduced by the digital pre-distorter cancel out with the non-linear distortions introduced by the power amplifier. The DPD may have inverse input-output characteristics to those of the PA. For example, the DPD may add reverse non-linearity to the signal, such that the serial combination of DPD followed by the PA may approach (e.g., may have) linear input-output characteristics. An efficient digital pre-distorter may help a UE to meet ACLR standards and to achieve improved power efficiency by operating the PA near its saturation region.

There can be challenges to designing an effective digital pre-distorter. Such challenges may include instability due to the non-linear nature of the DPD. Instability in general may lead to DPD that is less effective in achieving satisfactory ACLR. Instability may also lead to DPD parameters that are sufficiently large to cause overflow in the designated registers (e.g., bit-width overflow).

The non-linear operation of a DPD may be realized (e.g., determined and modeled) in terms of a polynomial. Coefficients of the polynomial (called “DPD coefficients”) may be design parameters (e.g., may be the main design parameters) and may determine the characteristics of the DPD. As used herein, the term “DPD coefficients” refers to values (e.g., one or more coefficients) of a polynomial, which determine (e.g., which represent) the non-linear characteristics of a given DPD. The DPD coefficients may be values (e.g., real numbers). The DPD coefficients may typically be computed using PA input and output signals (e.g., as training data) via a model fitting technique called least squares (LS). As discussed above, the instability of LS procedures, which occasionally produce coefficients with very large magnitude, can be a concern for DPD design. In some deployments (e.g., in normal deployments) of DPD, the DPD coefficients may be stored in designated registers of limited size. However, if the coefficients are sufficiently large, it may cause register overflow and consequently breakdown of DPD operation, which may lead to distortion causing interference and signal recovery error. In other words, overflow of DPD coefficient-storing registers in a memory of the UE may occur as a result of performing unconstrained LS operations based on computed DPD coefficients having sizes that exceed the size of their designated memory registers.

Some methods for generating DPD may involve complex computations (e.g., complex matrix computations, such as matrix inversion or singular value decomposition (SVD) of a large matrix) in addition to causing overflow.

In some systems, “ridge regression” may be used to address the general problem of instability by limiting the coefficients based on squaring each of the DPD coefficients and summing up the squares. However, such systems may focus on achieving reduced (e.g., minimum) modeling error and not achieving smaller magnitude in coefficients. A reduction in a sum of magnitudes may be a by-product of such approaches and may not guarantee that a worst coefficient's magnitude (e.g., a magnitude of the largest coefficient) will satisfy any specified upper bound. For example, although limiting the coefficients based on squaring each of the DPD coefficients and summing up the squares may successfully limit some coefficients, some coefficients may still individually exceed the limit.

Contrastingly, aspects of some embodiments of the present disclosure may jointly reduce (e.g., minimize) the modeling error and bound the largest magnitude of the regression coefficients (e.g., the DPD coefficients). In other words, aspects of some embodiments of the present disclosure may limit each DPD coefficient individually within an upper bound, such that none of the coefficients exceed the upper bound. The computation of DPD coefficients in some ridge-regression-based methods may be iterative and may suffer from computational complexity (e.g., heavy computational complexity) based on performing matrix inversion operations in each iteration.

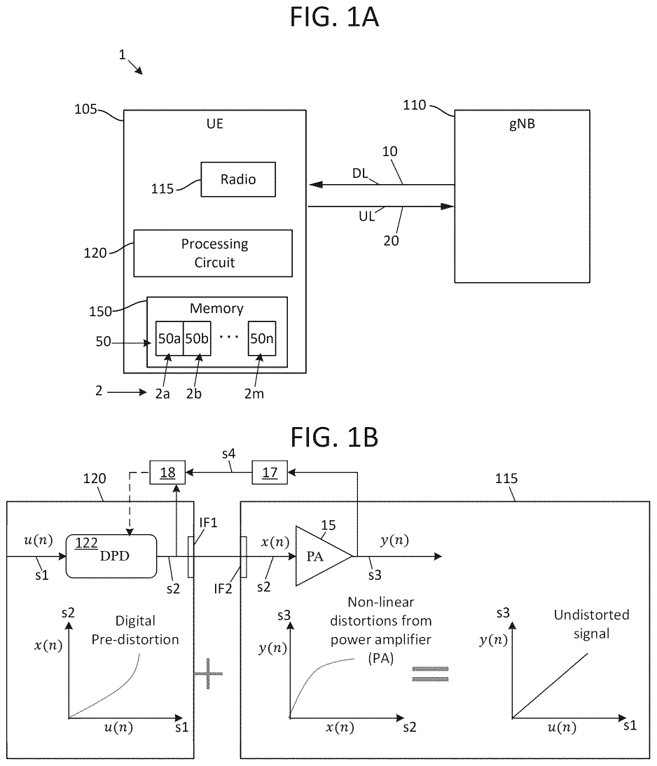

As discussed in further detail below with reference to FIG. 1A, the DPD coefficients may be stored in designated registers of limited size during deployment (e.g., during normal deployment). This, in turn, may put an upper bound on the magnitude of each coefficient. Aspects of some embodiments of the present disclosure enable DPD to be generated with component-wise amplitude upper bounded coefficients (e.g., DPD coefficients). By providing for an upper bound on the magnitude of each coefficient, aspects of some embodiments of the present disclosure may be naturally more suitable for scenarios involving designated registers of limited size.

Aspects of embodiments of the present disclosure provide a DPD design procedure in which each of the resulting coefficients satisfy a given magnitude upper bound (e.g., an amplitude upper bound). That is, the DPD coefficients may be computed by a digital pre-distorter via a model fitting approach while simultaneously reducing (e.g., eliminating) the source of instability. In some embodiments, the DPD coefficients may be computed iteratively to facilitate reducing complexity in each iteration. For example, matrix inversion used in some LS procedures (e.g., in some unconstrained LS procedures) may be simplified or avoided. In some embodiments, algorithm may perform a smaller number of iterations than the number of DPD coefficients.

Aspects of embodiments of the present disclosure may enable design of DPD coefficients satisfying a component-wise magnitude upper bound with low computational complexity.

Aspects of some embodiments of the present disclosure provide methods for DPD coefficient extraction (e.g., DPD coefficient determination) to reduce the complexity of computations for determining the DPD coefficients and for reducing the risk of (e.g., for preventing) overflow of DPD coefficient-storing registers.

Aspects of some embodiments of the present disclosure may improve (e.g., may guarantee) stability in DPD operation.

Aspects of some embodiments of the present disclosure may prevent overflow by determining each of the DPD coefficients such that each of the DPD coefficients satisfies a specified amplitude upper bound (e.g., a threshold) and such that the DPD coefficients achieve improved linearization of the power amplifier (e.g., such that the output of the power amplifier achieves an improved ACLR).

In summary, aspects of embodiments of the present disclosure may provide for the following advantages and improvements (over other methods of generating DPD), including the following. For a given storage size, DPD coefficients may be designed (e.g., determined) to fit in the registers without overflow while simultaneously achieving better ACLR than some schemes that are based on “ridge regression.” Computational complexity may be reduced from (e.g., may be much simpler than) other schemes. For example, matrix inversion operations, utilized by some methods, may be avoided or simplified. Computation of DPD coefficients may be completed in a smaller number of iterations than the number of DPD coefficients, while other methods may not be able to guarantee convergence in a fixed number of iterations. Robust compensation of the non-linear effects of a radio-frequency PA may allow a UE to meet output signal quality standards while improving the efficiency of the PA.

FIG. 1A is a block diagram depicting a system 1 including a UE 105 and a network node 110 for performing communications associated with the UE 105 generating DPD, according to some embodiments of the present disclosure.

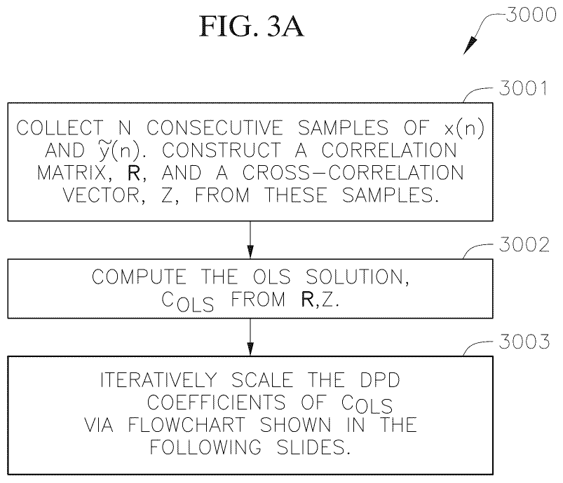

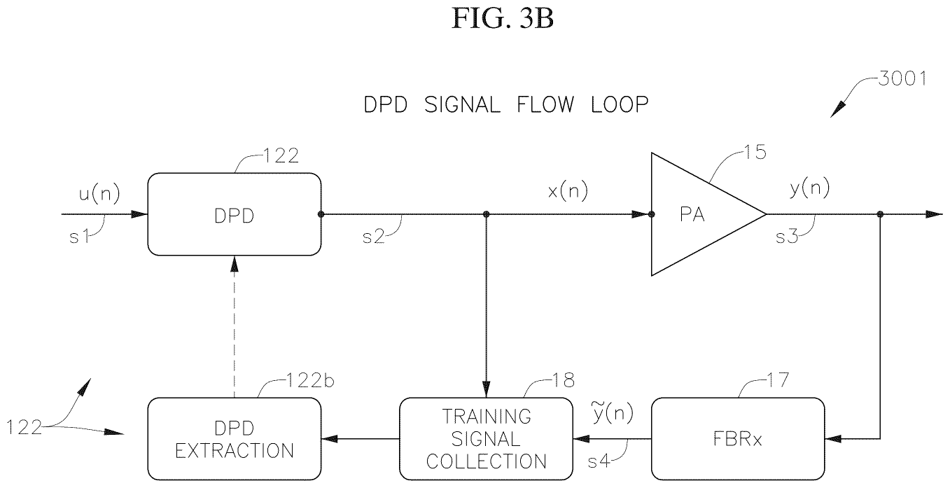

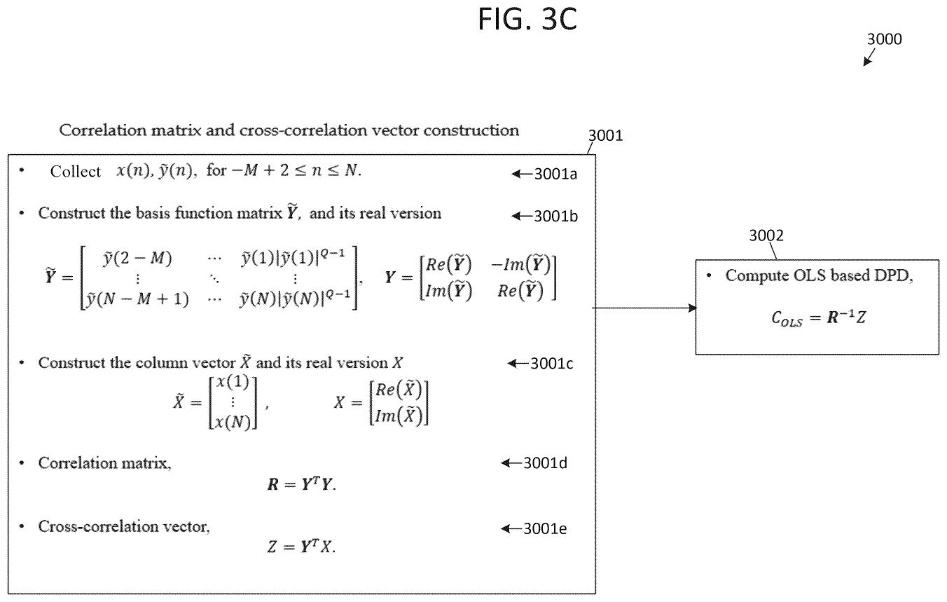

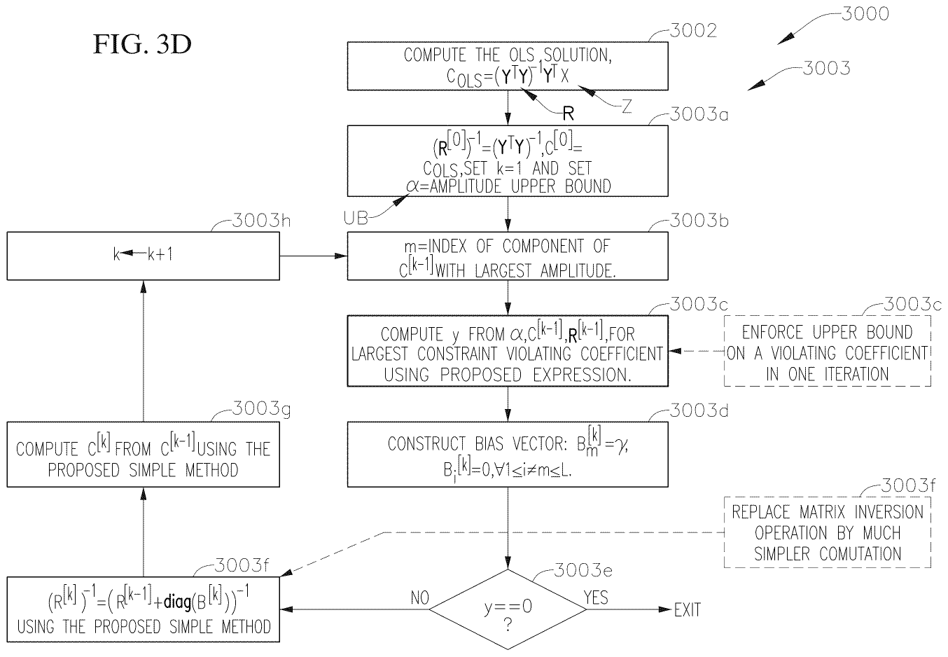

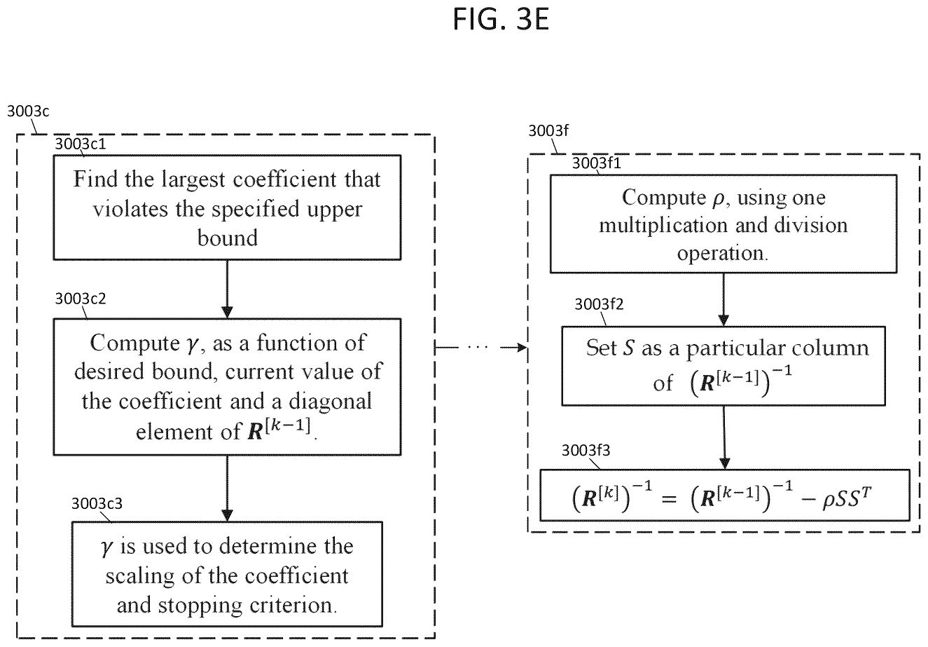

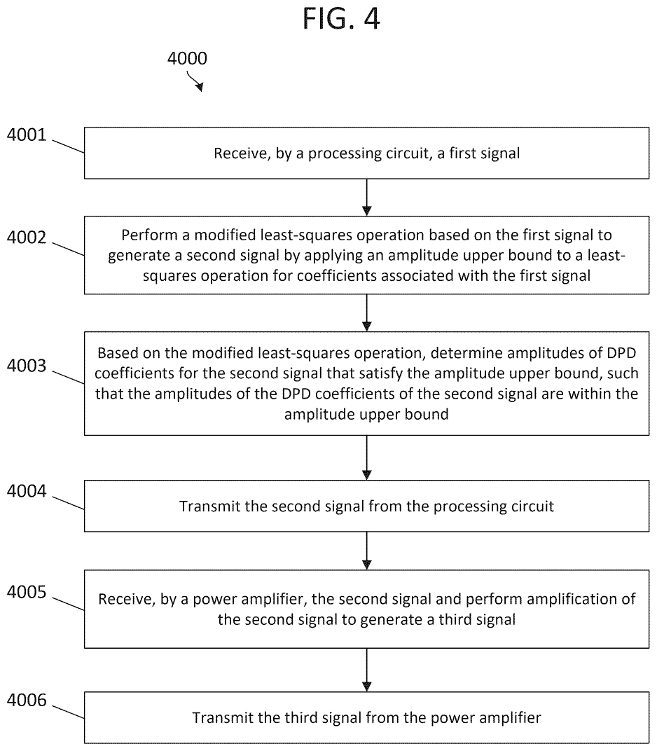

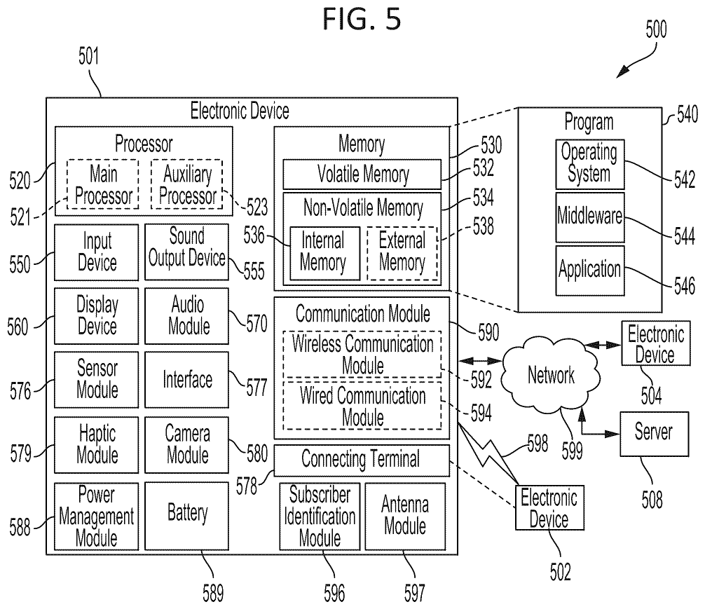

Referring to FIG. 1A, the system 1 may include the UE 105 and the network node 110 (e.g., the gNB) in communication with each other. The UE 105 may include a radio 115 and a means for processing. The means for processing may include a processing circuit 120, which may perform various methods disclosed herein (e.g., the methods depicted in FIGS. 3A, 3C, 3D, 3E, and 4). The radio 115 may correspond to the communication module 590 (see FIG. 5). The processing circuit 120 may correspond to the processor 520 (see FIG. 5). The processing circuit 120 may receive, via the radio 115, transmissions from the network node 110, and the processing circuit 120 may transmit, via the radio 115, signals to the network node 110. A transmission from the network node 110 may be provided to the UE 105 via a downlink (DL) transmission 10. A transmission from the UE 105 may be provided to the network node 110 via an uplink (UL) transmission 20.

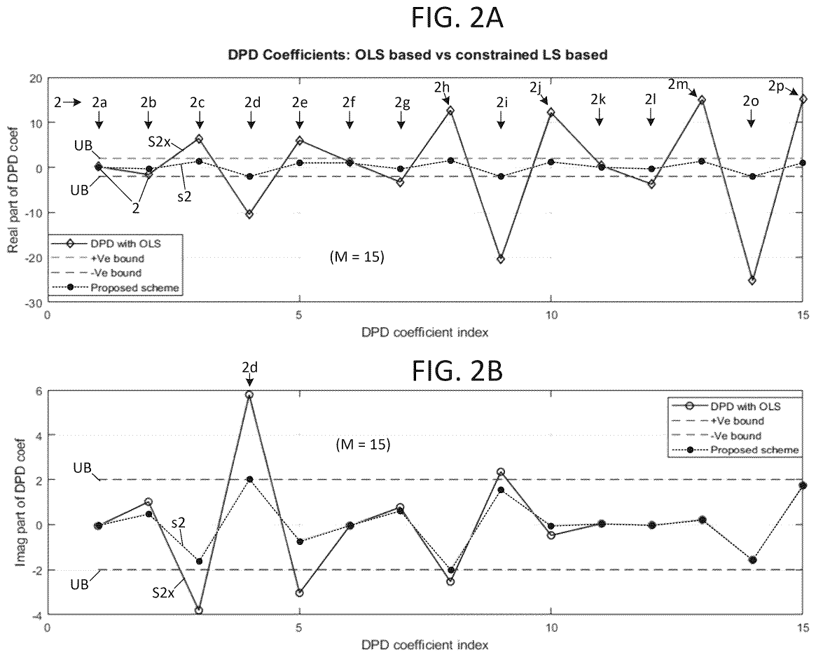

In some embodiments, the UE 105 includes a memory 150 (e.g., a volatile memory and/or a non-volatile memory). The memory 150 may store instructions for causing the processing circuit 120 to perform the various methods disclosed herein. The memory 150 may include one or more registers 50 (e.g., a first register 50a, a second register 50b, and an n-th register 50n). As used herein, a “register” refers to a memory location having a unit of memory (e.g., a memory space or block of memory having a given size of memory, such as a given bit-width). For example, a given register 50 may be a memory location allocated for storing (e.g., for saving) given DPD coefficients 2 (e.g., data associated with a given DPD coefficient 2). For example, the first register 50a may store data indicating a value of a first DPD coefficient 2a (see FIGS. 2A and 2B), the second register 50b may store data indicating a value of a second DPD coefficient, and the n-th register 50n may store data indicating a value of a third DPD coefficient 2m. In some embodiments, each register 50 may have a given size. For example, a register 50 having a size of 8 bits may be allocated to store data indicating a maximum DPD-coefficient value (e.g., decimal value) of 255, which is equal to the binary value 11111111 (represented by 8 bits). For example, a decimal value of 255 may represent an amplitude that is greater than an amplitude represented by a decimal value of 100, which is equal to the binary value of 01100100 (represented by 8 bits).

FIG. 1B is a block diagram depicting components of the UE 105 and associated signals, according to some embodiments of the present disclosure.

Referring to FIG. 1B, in some embodiments the processing circuit 120 may include a digital pre-distorter 122 (e.g., a digital pre-distorter circuit). The digital pre-distorter 122 may receive a first signal s1 (e.g., an orthogonal frequency-division multiplexing (OFDM) signal, also referred to as u(n)) and may generate a second signal s2 (e.g., a constrained DPD signal, also referred to as x(n)) based, in part, on coefficients associated with the first signal s1 (e.g., unconstrained coefficients generated based on the first signal s1). The processing circuit 120 may transmit (e.g., may send) the second signal s2 to a power amplifier 15. In some embodiments, the first signal s1 may be generated by a baseband block (e.g., a baseband circuit) of the UE 115. In some embodiments, the second signal s2 may be generated based on DPD coefficients (e.g., DPD coefficient values) stored in the registers 50 of the memory 150. In some embodiments, the digital pre-distorter 122 may be capable of retrieving DPD coefficients stored in different registers 50.

u(n) refers to an orthogonal frequency-division multiplexing (OFDM) signal generated by a baseband circuit (e.g., a baseband block) of the user equipment (UE). For example, the OFDM signal may be a signal that is to be amplified and transmitted from the UE to a base station. x(n) refers to a digital pre-distortion signal generated by a digital pre-distorter circuit (e.g., a pre-distorter block) of the user equipment (UE). y(n) refers to an output signal generated by the power amplifier (PA). \tilde{y} (n) refers to a processed feedback signal generated by a feedback receiver of the UE.

The radio 115 may include the power amplifier 15 to amplify the second signal s2. The processing circuit 120 may transmit the second signal s2 from a first interface IF1 of the processing circuit 120 to be received by the power amplifier 15 (e.g., via a second interface IF2 of the radio 115). The power amplifier 15 may generate a third signal s3 (e.g., an amplified output signal, also referred to as y(n)) based on the second signal s2. As discussed in further detail below, pre-distortion introduced into the second signal s2 may be determined (e.g., may be generated), such that it cancels out with non-linear distortions introduced by the power amplifier 15, and the output of the power amplifier 15 becomes an amplified version of the first signal s1 (e.g., with less distortion than there would be without the DPD introduced into the second signal s2).

The third signal s3 may be transmitted from the UE 105. For example, the third signal s3 may be an amplified version of the first signal s1 that is strong enough to be sent to, and received by, the network node 110. In some embodiments, the third signal s3 may also be processed by a feedback receiver 17 (FBRx) to generate a fourth signal s4 (e.g., a processed feedback signal, also referred to as \tilde{y}(n) or “y-tilde n”) for determining the DPD coefficients 2 of the second signal s2. In some embodiments, samples of the fourth signal s4 may be sent to a training and signal-collection circuit 18 along with samples from the second signal s2. For example, and as discussed in further detail below (e.g., with reference to FIGS. 3A and 3B), samples (e.g., consecutive samples) of the second signal s2 and the fourth signal s4 may be collected, by the digital pre-distorter 122 (e.g., via the training and signal-collection circuit 18), over one or more iterations of operations of a method for generating DPD, according to some embodiments of the present disclosure, to iteratively scale the DPD coefficients 2 from unconstrained coefficients determined by performing an unconstrained least-squares operation on the first signal s1. Although the FBRx 17 and the signal-collection circuit 18 are depicted outside of the processing circuit 120 and the radio 115, the present disclosure is not limited thereto. For example, the FBRx 17 and/or the signal-collection circuit 18 may be included in the processing circuit 120 and/or the radio 115.

For mathematical notion, as used herein, normal capital letters and bolded capital letters may respectively be used to denote column vectors and matrices. The i-th element of the column vector B is denoted by Bᵢ. The element at the i-th row and j-th column of a matrix A is denoted by A_{(i,j)}. A_{(i,:)} and A_{(:,j)} respectively represent the i-th row and the j-th column of the matrix A. A_{(i,:)} refers to the i-th row or all the elements in the i-th row. A_{(:,j)} refers to the j-th column or all the elements in the j-th column. The larger quantity between a real number p and zero is denoted by (p)⁺. That is, if p is a negative number, then (p)⁺=0, and if p is a non-negative number then (p)⁺=p. (·)^{[k]} denotes the quantity within the braces (e.g., within the parenthetical) at the k-th iteration. The column vector B may be used to construct another matrix, which may be added to the correlation matrix Y^{T}Y in an intermediate step of the DPD computation procedure. The correlation matrix Y^{T}Y may be used for the DPD computation procedure and may be constructed by multiplying a Y matrix with its transpose Y^{T}. p refers to a number arising during the calculation of the DPD procedure. p represents an arbitrary number. (p)⁺ refers to zero if p<0 or p=0, and (p)⁺ refers to p, if p>0. For example, in the DPD procedure, sometimes only the positive part of a particular number is used, but 0 is used if the number is not positive.

FIG. 2A and FIG. 2B are diagrams depicting an example of DPD coefficients of an unconstrained DPD signal s2x compared to an example of a second signal s2 (e.g., a constrained DPD signal), the second signal/constrained DPD signal being generated according to some embodiments of the present disclosure.

The non-linear characteristics of the DPD may be modeled using a polynomial (e.g., a memory polynomial), such as the following equation 1:

$$x ( n ) = {\sum }_{m = 0}^{M - 1} {\sum }_{q = 0}^{Q - 1} {C}_{m , q} * u ( n - m ) {( \vert u ( n - m ) \vert )}^{q} \qquad ( eqn . 1 )$$

wherein: u(n) refers to the first signal s1; m refers to a length or depth of memory (e.g., a number of input samples used to compute one output sample), which corresponds to a number of memory terms (e.g., a number of samples) associated with the DPD coefficients 2 (e.g., C_{m,q}) for the second signal s2; and q refers to the polynomial order (e.g., a largest exponent of an input sample among the terms that are combined to obtain one output sample), which corresponds to a degree of non-linearity for the second signal s2; M and Q correspond to the total number of different values of m and q for computing (e.g., m=0,1, . . . . M−1), and determine how much memory and how much non-linearity the DPD can compensate (e.g., can cancel out with respect to the non-linear distortions of the power amplifier). q indicates how many times the number should be multiplied by itself (e.g., 24=2×2×2×2=16). * refers to a conjugation operation for a complex number (e.g., (2+3i)*=2-3i). u(n−m) refers to a signal sample that appears m time units before the current sample u(n). In digital signal processing, signals are represented as a collection of samples indexed by an integer, which represents time. If u(n) represents the current sample, u(n−1) is a sample just one time unit before, u(n−2) is a sample two time units before, and so on. |u(n−m)| refers to the absolute value of u(n−m). Then (|u(n−m)|)^{q} is obtained by multiplying |u(n−m)| by itself q times. C refers to DPD coefficients (e.g., to a vector containing DPD coefficients).

Referring to FIG. 2A, a real part of the DPD coefficients is depicted as including fifteen DPD coefficients 2 (e.g., coefficients 2a, 2b, 2c, 2d, 2e, 2f, 2g, 2 h, 2i, 2j, 2k, 2l, 2m, 20, and 2p). FIG. 2A depicts the unconstrained DPD coefficients of the unconstrained DPD signal s2x (also referred to as ordinary least-squares (OLS) coefficients) compared to the constrained coefficients of the second signal s2 (e.g., the constrained coefficients of the constrained DPD signal). In some embodiments, the 15 DPD coefficients are indexed by (m,q) pairs, like (m=0,q=0), (0,1), (0,2), (0,3), (0,4), (m=1,q=0), (1,1), (1,2), (1,3), (1,4), (m=2,q=0), (2,1), (2,2), (2,3), (2,4).

Referring to FIG. 2B, an imaginary part of the DPD coefficients is depicted as including fifteen DPD coefficients 2 corresponding to the fifteen DPD coefficients 2 of FIG. 2A. As can be seen in both FIG. 2A and FIG. 2B, some of the DPD coefficients 2 of the unconstrained DPD signal s2x exceed an amplitude upper bound UB applied to the constrained coefficients of the second signal s2, while each of the DPD coefficients 2 of the second signal s2 (e.g., the constrained DPD signal) are within the amplitude upper bound UB (e.g., do not exceed the amplitude upper bound UB). For example, DPD coefficient 2d of the unconstrained DPD signal s2x exceeds the amplitude upper bound UB in both FIGS. 2A and 2B, while the DPD coefficient 2d of the second signal s2 is within the amplitude upper bound UB in both FIGS. 2A and 2B. As used herein, an “amplitude upper bound” refers to a limit on a maximum coefficient value (e.g., a maximum positive and/or negative value, such +2 or −2 as depicted in FIG. 2B).

FIG. 3A is a flowchart depicting example operations of a method 3000 for generating DPD, including a collection of samples, according to some embodiments of the present disclosure.

FIG. 3B is a block diagram depicting additional components/operations of the UE and associated signals, according to some embodiments of the present disclosure.

Although FIG. 3A illustrates various operations in a method for generating DPD, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

Referring to FIGS. 3A and 3B, during an initial phase (e.g., a training phase) for determining the DPD coefficients 2 (see FIGS. 1A, 2A and 2B), the digital pre-distorter 122 may not yet be present and, as such, the first signal s1 may be equal to the second signal s2. The second signal s2 may be sent to the power amplifier 15 for amplification and a number of samples of the second signal s2 may be sent to the training and signal-collection circuit 18. An output of the power amplifier 15 may send the third signal s3 to the FBRx 17 to generate the fourth signal s4. For example, the FBRx 17 may perform further processing on the third signal s3, such as removing noise, to generate the fourth signal s4. Samples of the fourth signal s4 may be input to the training and signal-collection circuit 18 along with the samples of the second signal s2 to perform non-linear modeling to construct the non-linear distortion that can reduce (e.g., cancel with) the non-linear distortions of the power amplifier 15.

For example, the training and signal-collection circuit 18 may collect N consecutive samples from the second signal s2 (which is initially equal to the first signal) and from the fourth signal s4 to construct a correlation matrix, R (also referred to as Y^{T}Y), and a cross-correlation vector Z, from the samples (operation 3001). The cross-correlation vector Z may be used to calculate the DPD coefficients.

The digital pre-distorter 122 (e.g., by way of a DPD extraction circuit 122b) may compute the OLS solution (Cos, also referred to as an unconstrained solution) from the correlation matrix, R, and the cross-correlation vector Z to construct the DPD using the following equations (e.g., operations) 1.2.1 and 1.2.2:

$$Compute {( {R}^{[ 0 ]} )}^{- 1} = {( {Y}^{T} Y )}^{- 1} , {C}^{[ 0 ]} = {C}_{OLS} = {( {R}^{[ 0 ]} )}^{- 1} {Y}^{T} X \qquad ( eqn . 1.2 \text{.1} )$$

$${B}^{[ 0 ]} = {0}_{L \times 1} and set α \qquad ( eqn . 1.2 \text{.2} )$$

(operation 3002). Here, Y^{T} refers to a rearrangement, referred to as “transpose,” of the elements of the matrix Y, and Y^{T}Y is the product of the two matrices. The exponent −1 refers to another matrix inversion operation that is known to one of skill in the art. At the beginning of the procedure R^{[0]}=R=Y^{T}Y. (R^{[0]})⁻¹ Y^{T}X stands for the product of three matrices shown therein. 0_{Lx1} refers to a column of length L containing only zeros. R^{[0]} refers to R at the beginning of the iterative algorithm. C^{[0]} refers to an initial solution for the DPD coefficients and also equal to C_{OLS}. B^{[0]} refers to an initial value of the vector B at the beginning of the iterative procedure, its an L-length column vector with zeros everywhere. 0_{Lx1} refers to an L-length column vector with zeros everywhere. α is the desired bound that the amplitude of each DPD coefficient needs to satisfy. As discussed above, the unconstrained solution may include some DPD coefficients 2 that are too large and exceed the upper bound UB (see FIGS. 2A and 2B). For example, the unconstrained solution may include coefficients similar to some of the coefficients of the unconstrained DPD signal s2x of FIGS. 2A and 2B. C_{OLS} refers to an ordinary least squares (OLS) DPD coefficient, which has no amplitude constraint on its value. X refers to a column vector containing a PA input training sequence. T refers to a symbol used to denote the matrix operation called “transpose.”

To avoid the problems discussed above (which can result from the overflow of DPD coefficient-storing registers in the memory of the UE, caused by DPD coefficients exceeding the upper bound UB), the digital pre-distorter 122 (e.g., by way of a DPD extraction circuit 122b) may iteratively scale the DPD coefficients 2 (e.g., the unconstrained DPD coefficients) to generate the second signal s2 as a constrained version of the first signal 1, as represented by the unconstrained DPD signal s2x (operation 3003). As used herein, the “first signal s1” may be used to refer to (i) the first signal without any DPD operations performed thereon and/or (ii) the unconstrained DPD signal s2x after an unconstrained least-squares operation has been performed on the first signal s1. The DPD coefficients 2 of the second signal s2 may be determined such that bits representing all of the DPD coefficients of the second signal s2 may be stored in respective first memory locations (e.g., in certain ones of the registers 50) allocated for storing the DPD coefficients of the second signal s2, without any of the bits overflowing to second memory locations (e.g., into different ones of the registers 50 not intended for storing those bits).

FIG. 3C is a flowchart depicting further mathematical details of some of the example operations of the method 3000 of FIG. 3A, according to some embodiments of the present disclosure.

Although FIG. 3C illustrates various operations in a method for generating DPD, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

Referring to FIG. 3C, the digital pre-distorter 122 (e.g., by way of the DPD extraction circuit 122b) may collect samples from the second signal s2 and the fourth signal s4 (operation 3001a). The digital pre-distorter 122 (e.g., by way of the DPD extraction circuit 122b) may construct the basis function matrix Y-tilde and its real version Y matrix (operation 3001b). N refers to the number of complex training samples. In some embodiments, 2*N real training samples may be obtained from the complex training samples. M refers to the memory depth of the system. The memory depth may determine the largest delayed sample taken into account during a computation.

Y (also referred to as Y-tilde) refers to a matrix constructed from the complex PA output samples, where a complex sample in turn refers to a pair of real samples. As a result, this matrix contains complex numbers. Re (\tilde{Y}) refers to a matrix with only real components of the matrix \tilde{Y}. −Im(\tilde{Y}) refers to a matrix with only imaginary components of the matrix \tilde{Y}. Im(\tilde{Y}) refers to a matrix with only imaginary components of the matrix Y.

The digital pre-distorter 122 (e.g., by way of the DPD extraction circuit 122b) may construct the column vector X-tilde and its real version X vector (operation 3001c). \tilde{X} (also referred to as X-tilde) refers to a vector constructed from the complex PA input samples. The digital pre-distorter 122 (e.g., by way of the DPD extraction circuit 122b) may construct the correlation matrix R (operation 3001d). The digital pre-distorter 122 (e.g., by way of the DPD extraction circuit 122b) may construct the cross-correlation vector Z (operation 3001e). The digital pre-distorter 122 (e.g., by way of a DPD extraction circuit 122b) may compute the unconstrained DPD coefficients 2 by performing unconstrained least-squares operations on the first signal based on the correlation matrix R and the cross-correlation vector Z (operation 3002).

FIG. 3D is a flowchart depicting additional operations of the method 3000 of FIG. 3A, including amplitude-bounded DPD coefficient computations and simplified matrix computations, according to some embodiments of the present disclosure.

Although FIG. 3D illustrates various operations in the method 3000 for generating DPD, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

Referring to FIG. 3D, as discussed above, the digital pre-distorter 122 (e.g., by way of the DPD extraction circuit 122b (see FIGS. 1B and 3B)) may compute the unconstrained DPD coefficients 2 (e.g., C_{OLS}) by performing unconstrained least-squares operations on the first signal s1 based on the correlation matrix R and the cross-correlation vector Z (operation 3002). The determination (e.g., the computation) of the unconstrained DPD coefficients 2 may result in a set of initial DPD coefficients (e.g., C^{[k-1]}) having some coefficients that may result in register overflow, as discussed above.

Operations 3003a through 3003h may be considered sub-operations or further details of operation 3003 (see FIG. 3A). The digital pre-distorter 122 (e.g., by way of the DPD extraction circuit 122b) may set an iteration count k to 1 and may set the amplitude upper bound UB (e.g., a) (operation 3003a). k refers to a given iteration of generating DPD. The amplitude upper bound UB may be provided (e.g., may be predetermined) based on the size (e.g., a bit width) of the registers 50 (see FIG. 1A) to avoid register overflow.

The operations 3003a through 3003h may be referred to as operations of a modified least-squares operation (e.g., a constrained least-squares operation), which are operations for determining amplitudes of the DPD coefficients 2 for the second signal s2 that satisfy the amplitude upper bound UB, such that the amplitudes of the DPD coefficients 2 of the second signal s2 are within the amplitude upper bound UB (e.g., do not exceed the amplitude upper bound UB, such that register overflow may be avoided).

As used herein, a “modified least-squares operation” (also referred to as a “constrained least-squares operation”) refers to applying an amplitude upper bound individually to one or more coefficients of a DPD signal, instead of, for example, applying an upper bound to a summation of the coefficients of the DPD signal (e.g., a summation of the squares of the coefficients of the DPD signal). For example, values of the amplitudes of the DPD coefficients of a constrained DPD signal, generated by a modified least-squares operation, may be constrained DPD coefficients that are less than or equal to the amplitude upper bound UB. In some embodiments, a modified least-squares operation may include iteratively scaling the coefficients associated with the first signal s1 (obtained from an OLS method) that exceed the amplitude upper bound UB (e.g., by starting with the largest violating coefficient in a first iteration and moving on to the next largest violating coefficient in a second iteration). In some embodiments, a modified least-squares operation may include performing a simplified matrix inversion operation.

For example, the digital pre-distorter 122 (e.g., by way of the DPD extraction circuit 122b) may determine whether any unconstrained coefficients exceed the amplitude upper bound UB and may determine the index m of the component of C^{[k-1]} having the largest amplitude using the following equation 1.3:

$$m = arg {max}_{1 \leq i \leq L} \{ {( \vert {C}_{i}^{[ k - 1 ]} \vert - α )}^{+} \} \qquad ( eqn . 1.3 )$$

$$( operation 3003 b ) . arg {max}_{1 \leq i \leq L} \{ \}$$

refers to a value of i for which the expression that follows this symbol attains its maximum value. The subscript i represents the index of the DPD coefficient (this can be any number between 1 and 30 for the example provided). The superscript indicates that the coefficients obtained from iteration number (k−1) are being checked.

$$\vert {C}_{i}^{[ k - 1 ]} \vert$$

represents the amplitude of the i-th coefficient during (k−1)-th iteration. Then,

$${( \vert {C}_{i}^{[ k - 1 ]} \vert - α )}^{+} is equal to ( \vert {C}_{i}^{[ k - 1 ]} \vert - α ) if \vert {C}_{i}^{[ k - 1 ]} \vert$$

is larger than α otherwise,

$${( \vert {C}_{i}^{[ k - 1 ]} \vert - α )}^{+} = 0. {( \vert {C}_{i}^{[ k - 1 ]} \vert - α )}^{+}$$

refers to the difference of amplitude of the i-th component of the DPD vector from the previous iteration and α. If

$$( \vert {C}_{i}^{[ k - 1 ]} \vert - α )$$

is set to p, then the definition of (p)⁺ is as discussed above. The above operation (eqn. 1.3) is carried out for all coefficients from 1 to L and then the index (value of i), corresponding to the value of

$${( \vert {C}_{i}^{[ k - 1 ]} \vert - α )}^{+}$$

that is the largest, is set to m. m refers to a coefficient memory (e.g., a number of previous coefficients in a polynomial) and may be used as an index component of a k−1-th coefficient (e.g., C^{[k-1]}) having the largest amplitude. For example, if the largest unconstrained DPD coefficient from the unconstrained DPD signal s2x (see FIGS. 2A and 2B) is 24 and the amplitude upper bound UB is set to 4, the digital pre-distorter 122 may perform operations 3003c through 3003h on the largest unconstrained DPD coefficient before any other components of C^{[k-1]}. The symbol m represents the index of the coefficient having the largest amplitude.

The operations 3003c through 3003h may be used to modify the R matrix to construct a new vector, referred to as a column vector, bias vector, or B vector

$$( {B}_{m}^{[ k ]} ) ,$$

to construct a new R matrix that is used to determine constrained DPD coefficients for the second signal s2. For example, the digital pre-distorter 122 may enforce (e.g., apply or impose) the amplitude upper bound UB on a violating coefficient in one iteration (e.g., on each violating coefficient one-at-a-time) by computing a ridge parameter γ (gamma, also referred to as a bias parameter) from the amplitude upper bound UB (α), the initial coefficients C^{[k-1]}, and the R matrix (R^{[k-1]}) for the largest constraint violating coefficient (operation 3003c), using the following equation 2:

$$\begin{matrix}γ = \frac{{( \vert {C}_{m}^{[ k - 1 ]} \vert - α )}^{+}}{{α [ {( {R}^{[ k - 1 ]} )}^{- 1} ]}_{( m , m )}} , & {B}_{i}^{[ k ]} = \{ \begin{matrix}γ , & i = m ; \\ 0 , & i \neq m ;\end{matrix}\end{matrix} \qquad ( eqn . 2 )$$

In some embodiments,

$${( \vert {C}_{m}^{[ k - 1 ]} \vert - α )}^{+}$$

is computed as described above. (R^{[k-1]})⁻¹ is the inverse of R^{[k-1]} and [(R [k−1])⁻¹]_{(m,m)} is the element in m-th row and m-th column of the matrix

$${( {R}^{[ k - 1 ]} )}^{- 1} , \qquad {B}_{i}^{[ k ]}$$

refers to the i-th element of a column vector B^{[k]}. The operation suggests that the column vector B^{[k]} is a column vector whose m-th element is γ and everywhere else the column vector B^{[k]} has zeros. The digital pre-distorter 122 may construct the bias vector B based on the following equation 3:

$${B}_{m}^{[ k ]} = γ , {B}_{i}^{[ k ]} = 0 , ∀ 1 \leq i \neq m \leq L \qquad ( eqn . 3 )$$

$$( operation 3003 d ) . {B}_{m}^{[ k ]}$$

refers to the m-th component of the B vector during the k-th iteration.

$${B}_{i}^{[ k ]} = 0 , ∀ 1 \leq i \neq m \leq L$$

indicated the B^{[k]} is a column vector whose components are all zero, except the m-th component. V is a mathematical symbol equivalent to the English phrase “for all.”

The bias vector may be used to modify the inverse of the correlation matrix from the previous iteration, (R^{[k-1]})⁻¹, to compute the inverse to be used in the current iteration, i.e., (R^{[k]})⁻¹.

The digital pre-distorter 122 may determine whether a stopping criterion has been met by determining whether the ridge parameter γ is non-zero or zero (operation 3003e). γ may be interpreted as a variable that decides whether the algorithm should progress or stop. γ may dictate the stopping criterion of the DPD procedure. The DPD procedure continues if γ>0 and stops/concludes if it is equal to zero. When the ridge parameter γ is zero (“Yes,” in FIG. 3D), the iterations of operations 3003b through 3003h may be exited (e.g., stopped) because it means that all of the DPD coefficients satisfy the amplitude upper bound UB. When the ridge parameter γ is non-zero (“No,” in FIG. 3D), the iterations of operations 3003b through 3003h may continue. γ==0 refers to comparing γ to zero to determine a stopping criterion for generating DPD. For example, if γ is greater than 0, then further iterations are performed.

The digital pre-distorter 122 may perform a simplified matrix operation (e.g., a simplified matrix inversion) using the following equation 4.1:

$${( {R}^{[ k ]} )}^{- 1} = {( {R}^{[ k - 1 ]} + diag ( {B}^{[ k ]} ) )}^{- 1} \qquad ( eqn . 4.1 )$$

which may be simplified based on the following equations 4.2.1 and 4.2.2 to the following equation 4.2.3:

$$ρ = \frac{γ}{( 1 + {γ [ {( {R}^{[ k - 1 ]} )}^{- 1} ]}_{( m , m )} )} , \qquad ( eqn . 4.2 \text{.1} )$$

$$S = {[ {( {R}^{[ k - 1 ]} )}^{- 1} ]}_{( : , m )} \qquad ( eqn . 4.2 \text{.2} )$$

$${( {R}^{[ k ]} )}^{- 1} = {( {R}^{[ k - 1 ]} )}^{- 1} - ρ S {S}^{T} \qquad ( eqn . 4.2 \text{.3} )$$

to determine the new R matrix that is used to determine constrained DPD coefficients for the second signal s2. (operation 3003f). As used herein, a “simplified matrix operation” refers to reducing a number of computations normally associated with a matrix inversion operation.

In equation 4.1 above, diag(B) refers to a diagonal matrix containing the Lagrangian multipliers, β₁, . . . . β_{L}, along the diagonal of the matrix, as in the following diagonal matrix example 1 (ex. 1):

$$diag ( B ) = [ \begin{matrix}{β}_{1} & 0 & … \\ 0 & ⋱ & 0 \\ ⋮ & 0 & {β}_{L}\end{matrix} ] \qquad ( ex . 1 )$$

wherein only one non-zero component B; is positioned in the matrix for a given iteration, the position of the non-zero component corresponding to the index m of the given DPD coefficient; β₁ refers to a non-zero component associated with a first index, i.e., when m=1; and β_{L} refers to a non-zero component associated with a last index, i.e., m=L.

The digital pre-distorter 122 may determine a reduced-amplitude DPD coefficient C^{[k]} from C^{[k-1]} using the simplified matrix operation method and based on the following equation 4.3:

$${C}^{[ k ]} = {C}^{[ k - 1 ]} - S * {C}_{m}^{[ k - 1 ]} \qquad ( eqn . 4.3 )$$

such that the DPD coefficient C^{[k]}, corresponding to the largest of the unconstrained DPD coefficients C^{[k-1]}, is smaller than the amplitude upper bound UB (operation 3003g).

The digital pre-distorter 122 may increment the iteration count k (e.g., k+1) to enter the next iteration (e.g., the second iteration) of amplitude-bounded DPD coefficient computation to apply the amplitude upper bound UB constraint on the largest remaining violating unconstrained DPD coefficient to determine the DPD coefficients for the second signal s2.

The simplified matrix operation of equation 4.1 may result in a reduction (e.g., a significant reduction) in computing complexity, based on a number of computations being L², as opposed to L³ for a normal matrix inversion operation. For example, for L=30 coefficients (e.g., DPD coefficients), the corresponding correlation matrix may have 900 elements (e.g., 30×30), and 30³=27000 computations with a normal matrix inversion operation. In some embodiments of the present disclosure, the number of computations would be 30²=900. As used herein, and unless noted otherwise, L refers to a maximum value of the index, or the number of coefficients in a DPD.

Table 1 below is a summary of the mathematical descriptions for operations 3003a through 3003h discussed above, which may also be referred to as operations of a regression parameter-computing algorithm.

TABLE 1
Regression parameter-computing algorithm.

| Initialization and OLS | Compute (R^{[0]})⁻¹ = (Y^{T}Y)⁻¹, C^{[0]} = C_{OLS} = |
|---|---|
| solution (operation 3003a) | (R^{[0]})⁻¹Y^{T}X B^{[0]} = 0_{L×1} and set α. |
| (operation 3003a) | For k = 1, 2, . . . do following until stopping |
| | criterion is met. |
| Step #1 (operation 3003b) | $m = arg {max}_{1 \leq i \leq L} \{ {( \vert {C}_{i}^{[ k - 1 ]} \vert - α )}^{+} \} ,$ |
| Step #2 (operation 3003c) | $γ = \frac{{( \vert {C}_{i}^{[ k - 1 ]} \vert - α )}^{+}}{{α [ {( {R}^{[ k - 1 ]} )}^{- 1} ]}_{( m , m )}} , {B}_{i}^{[ k ]} = \{ \begin{matrix}γ , & i = m ; \\ 0 , & i \neq m ;\end{matrix}$ |
| Stopping criterion | γ = 0. |
| (operation 3003e) | |
| Step #3 (operation 3003f) | $ρ = \frac{γ}{( 1 + {γ [ {( {R}^{[ k - 1 ]} )}^{- 1} ]}_{( m , m )} )} ,$ |
| | S = [(R^{[k-1]})⁻¹]_{(;,m)} |
| | (R^{[k]})⁻¹ = (R^{[k-1]})⁻¹ − ρSS^{T} |
| Step #4 (operation 3003g) | ${C}^{[ k ]} = {C}^{[ k - 1 ]} - S * {C}^{[ k - 1 ]}$ |
| Step #5 (operation 3003h) | k ← k + 1 and go to step #1 (k may assume the |
| | value of k + 1, increasing the value of k by 1) |

The foregoing algorithm ensures that the Lagrange multipliers (bias parameters) in the following equation 5.1:

$${C}_{G R R} = {( {Y}^{T} Y + diag ( B ) )}^{- 1} {Y}^{T} X \qquad ( eqn . 5.1 )$$

satisfy the complementary slackness constraint of the Karush-Kuhn-Tucker (KKT) KKT conditions. As used herein, a “complementary slackness constraint” refers to an expression/constraint that appears in the KKT method of solving an optimization problem. diag (B) refers to a diagonal matrix containing Lagrangian multipliers, β₁, . . . β_{L}, along its diagonal. β₁ refers to a first Lagrangian multiplier. β_{L} refers to an L-th Lagrangian multiplier. The output of the algorithm thus satisfies all the suitable and sufficient KKT conditions and therefore is a suitable (e.g., an optimal solution) of the constrained optimization problem associated with the following equation 5.1:

$${C}_{G R R} = arg {{min}_{\begin{matrix}{C}_{i}^{2} \leq {α}^{2} , & 1 \leq i \leq L\end{matrix}} ( YC - X )}^{T} ( YC - X ) \qquad ( eqn . 5.2 )$$

$$arg {min}_{C}$$

refers to a value of C for which the expression that follows this symbol attains its minimum value. Y refers to a matrix containing basis functions constructed from output signal sequence y(n). C_{GRR} refers to a ridge regression coefficient (e.g., C_{GRR,i} refers to an i-th regression coefficient). The ridge regression coefficients may be used as the DPD coefficients. α refers to the upper bound to the amplitude of each DPD coefficient.

$${C}_{i}^{2} \leq {α}^{2} , \qquad 1 \leq i \leq L$$

refers to upper bound in mathematical form. (YC−X)^{T} refers to the transpose of the matrix (YC−X). (YC−X) refers to an error vector. Y^{T}X refers to a cross-correlation vector (sometime denoted by Z), which is used to compute DPD coefficients. The cross-correlation vector may be constructed by a matrix multiplication between transpose of the Y matrix Y^{T} and the column vector X.

FIG. 3E is a flowchart depicting further details of some of the example operations of the method 3000 of FIG. 3D, according to some embodiments of the present disclosure.

Although FIG. 3E illustrates various operations in a method for generating DPD, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

Referring to FIG. 3E, operation 3003c may include sub-operations. For example, the digital pre-distorter 122 may find the largest coefficient that violates the specified amplitude upper bound UB (operation 3003c1). The digital pre-distorter 122 may compute the ridge parameter γ as a function of the desired amplitude upper bound UB, the current value of the coefficient and a diagonal element of, R^{[k-1]} (operation 3003c2). The digital pre-distorter 122 may use the ridge parameter γ to determine the scaling of the coefficient and stopping criterion (operation 3003c3).

Operation 3003f may include sub-operations. For example, the digital pre-distorter 122 may compute ρ using one multiplication and division operation (3003f1). The digital pre-distorter 122 may set S as a particular column of (R^{[k-1]})⁻¹ (operation 3003f2). The digital pre-distorter 122 may modify (e.g., may simplify) the inverse matrix operation into a subtraction operation (−ρSS^{T}) based on ρ and S (operation 3003f3). In some embodiments, ρ is computed from γ and a particular element on the diagonal of the correlation matrix as shown in Table 1 (step #3). In each iteration of the proposed method, first the index of the coefficients may be found and is denoted by m (e.g., see Table 1). S represents the corresponding column of the correlation matrix, i.e., in the notations introduced in 0056, S=[(R^{[k-1]})⁻¹]_{(:,m)}.

Meanings of Some of the Mathematical Symbols from Table 1

[(R^{[K-1]})⁻¹]_{(m,m)} refers to the inverse of the correlation matrix obtained at the end of the (k−1)-th iteration. [(R^{[K-1]})⁻¹]_{(m,m)} refers to the element of (R^{[k-1]})⁻¹ at the m-th row and m-th column or the m-th element on its diagonal.

$${B}_{i}^{[ k ]} = \{ \begin{matrix}γ , & i = m ; \\ 0 , & i \neq m ;\end{matrix}$$

refers to a regression bias vector. By construction,

$${B}_{i}^{[ k ]}$$

is a column vector with zeros everywhere only except at the m-th position where its value is γ. ρ refers to an intermediate value in an algorithm. S=[(R^{[k-1]})⁻¹]_{(:,m)} refers to a column vector used to compute the inverse of a correlation matrix in an alternative manner. ρSS^{T} refers to a matrix. By construction, multiply S is multiplied with its transpose, which is a row vector, and the result is multiplied with

$$ρ . S * {C}_{m}^{[ k - 1 ]}$$

refers to a product of S and m-th component of the DPD vector from the previous iteration. k←k+1 refers to the operation of increasing the value of k by one.

FIG. 4 is a flowchart depicting an overview of example operations of a method for generating DPD, according to some embodiments of the present disclosure.

Although FIG. 4 illustrates various operations in a method for generating DPD, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

Referring to FIG. 4, the method 4000 may include one or more of the following operations. A processing circuit 120 (see FIGS. 1A and 1B) may receive a first signal (e.g., s1 of FIG. 3B) and a second signal (e.g., the fourth signal s4 of FIG. 3B) (operation 4001).

For example, as discussed above with reference to FIGS. 1B and 3B, the digital pre-distorter 122 may receive the first signal s1 that is to be amplified. The fourth signal s4 (e.g., samples of the fourth signal s4) may be sent to a training and signal-collection circuit 18 along with samples from the second signal s2 of FIG. 3B and may be collected by the digital pre-distorter 122.

The processing circuit 120 may perform a modified least-squares operation (e.g., a constrained least-squares operation) based on the first signal (e.g., s1 of FIG. 3B) and the second signal (e.g., s4 of FIG. 3B) to generate a set of DPD coefficients (see, e.g., 2a through 2p of FIGS. 2A and 2B). The performing of the modified least-squares operation may include performing one or more operations (see, e.g., eqn. 1) on the first signal (e.g., s1 of FIG. 3B) and the second signal (e.g., s4 of FIG. 3B), such that amplitudes of the DPD coefficients satisfy an amplitude upper bound UB (see, e.g., UB of FIGS. 2A and 2B) (operation 4002).

The processing circuit 120 may generate a third signal (e.g., s2 of FIG. 3B) based on the set of DPD coefficients (operation 4003).

For example, as discussed above with reference to FIGS. 2A, 2B, 3B, 3D, and 3E, the digital pre-distorter 122 may apply an amplitude upper bound UB to each coefficient of the unconstrained DPD coefficients that exceeds the upper bound by reducing the largest violating coefficients first, such that they are within the amplitude upper bound UB.

The processing circuit 120 may transmit, via a first interface IF1 (see, e.g., FIG. 1B), the third signal (e.g., s2 of FIG. 3B) from the processing circuit 120 to a power amplifier 15 (operation 4004).

For example, as discussed above with reference to FIG. 1B, the digital pre-distorter 122 may transmit the second signal s2 (see, e.g., FIG. 3B) to the power amplifier 15 to generate the third signal s3 as an amplified version of the first signal s1, with a reduced amount of non-linear distortion than would be present without the DPD from the digital pre-distorter 122.

The power amplifier 15 may receive the third signal (e.g., s2 of FIG. 3B) and perform amplification of the third signal (e.g., s2 of FIG. 3B) to generate a fourth signal (e.g., s3 of FIG. 3B) (e.g., an amplified output signal) (operation 4005).

For example, as discussed above with reference to FIG. 1B, the constrained DPD coefficients used for generating the second signal s2 may cause the non-linear distortions that would otherwise be produced by the power amplifier 15 to be canceled out with the DPD coefficients, such that the third signal s3 becomes closer to an amplified copy of the first signal s1.

The fourth signal (e.g., s3) may be transmitted from the power amplifier 15 (operation 4006). For example, the power amplifier 15 may send the fourth signal (e.g., s3 of FIG. 3B) to an antenna module 597 (see FIG. 5) to transmit the fourth signal (e.g., s3) to a network node 110 (e.g., a gNB).

For example, as discussed above with reference to FIGS. 1A and 1B, the UE 105 may transmit the third signal s3 (or another signal processed based on the third signal s3) to the network node 110 (e.g., the gNB) via a UL transmission 20.

Accordingly, aspects of some embodiments of the present disclosure may provide improvements to generating digital pre-distortion by allowing for DPD coefficients to be determined to satisfy an amplitude upper bound and reduce the risk of overflow in memory and by reducing a compute complexity associated with performing a least-squares operation to determine the DPD coefficients.

FIG. 5 is a block diagram of an electronic device in a network environment 500, according to some embodiments of the present disclosure.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the disclosed embodiments of the present invention.

While aspects of some embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A method for generating digital pre-distortion (DPD), the method comprising:
receiving, by a processing circuit of a user equipment (UE), a first signal;
receiving, by the processing circuit, a second signal generated based on an output of a power amplifier of the UE;
performing, by the processing circuit, a modified least-squares operation based on the first signal and the second signal to generate a set of DPD coefficients, the performing of the modified least-squares operation comprising performing one or more operations on the first signal and the second signal, such that amplitudes of the set of DPD coefficients satisfy an amplitude upper bound;
generating a third signal based on the set of DPD coefficients; and
transmitting the third signal from the processing circuit.

2. The method of claim 1, further comprising:
receiving, by the power amplifier of the UE, the third signal; and
performing, by the power amplifier of the UE, amplification of the third signal to generate a fourth signal; and
transmitting the fourth signal from the UE.

3. The method of claim 1, wherein the amplitude upper bound is associated with a bit-width of a unit of memory associated with storing the set of DPD coefficients.

4. The method of claim 1, further comprising saving bits representing all of the DPD coefficients of the set of DPD coefficients in a first memory location allocated for storing the DPD coefficients, without any of the bits overflowing to a second memory location.

5. The method of claim 1, further comprising performing an initial ordinary least-squares procedure to generate initial DPD coefficients,
wherein the performing of the modified least-squares operation further comprises iteratively scaling one or more of the initial DPD coefficients that exceed the amplitude upper bound.

6. The method of claim 1, wherein the performing of the modified least-squares operation further comprises determining a largest coefficient among initial coefficients obtained from an initial ordinary least-squares procedure.

7. The method of claim 1, wherein the performing of the modified least-squares operation further comprises iteratively scaling initial coefficients, obtained from an initial ordinary least-squares procedure, that exceed the amplitude upper bound relative to a size of a largest coefficient among the initial coefficients.

8. The method of claim 1, wherein the performing of the modified least-squares operation further comprises performing a simplified matrix inversion operation.

9. A system comprising:
a processing circuit configured to:
receive a first signal and a second signal, the second signal being generated based on an output of a power amplifier;
perform a modified least-squares operation based on the first signal and the second signal to generate a set of DPD coefficients, the performing of the modified least-squares operation comprising performing one or more operations on the first signal and the second signal, such that amplitudes of the set of DPD coefficients satisfy an amplitude upper bound;
generate a third signal based on the set of DPD coefficients; and
transmit the third signal from an interface of the processing circuit.

10. The system of claim 9, wherein the power amplifier is configured to:
receive the third signal; and
amplify the third signal to generate a fourth signal.

11. The system of claim 9, wherein the amplitude upper bound is associated with a bit-width of a unit of memory associated with storing the set of DPD coefficients.

12. The system of claim 9, wherein the processing circuit is configured to perform saving bits representing all of the DPD coefficients of the set of DPD coefficients in a first memory location allocated for storing the DPD coefficients, without any of the bits overflowing to a second memory location.

13. The system of claim 9, wherein the processing circuit is configured to:
perform an initial ordinary least-squares procedure to generate initial DPD coefficients,
wherein the performing of the modified least-squares operation further comprises iteratively scaling one or more of the initial DPD coefficients that exceed the amplitude upper bound.

14. The system of claim 9, wherein the performing of the modified least-squares operation further comprises determining a largest coefficient among initial coefficients obtained from an initial ordinary least-squares procedure.

15. The system of claim 9, wherein the performing of the modified least-squares operation further comprises iteratively scaling initial coefficients, obtained from an initial ordinary least-squares procedure, that exceed the amplitude upper bound relative to a size of a largest coefficient among the initial coefficients.

16. The system of claim 9, wherein the performing of the modified least-squares operation further comprises performing a simplified matrix inversion operation.

17. A device comprising:
a processing circuit; and
a memory storing instructions, which, based on being executed by the processing circuit, cause the processing circuit to:
receive a first signal and a second signal, the second signal being generated based on an output of a power amplifier;
perform a modified least-squares operation based on the first signal and the second signal to generate a set of DPD coefficients, the performing of the modified least-squares operation comprising performing one or more operations on the first signal and the second signal, such that amplitudes of the set of DPD coefficients satisfy an amplitude upper bound;
generate a third signal based on the set of DPD coefficients; and
transmit the third signal from the processing circuit.

18. The device of claim 17, wherein the power amplifier is configured to:
receive the third signal; and
amplify the third signal to generate a fourth signal.

19. The device of claim 17, wherein the instructions, based on being executed by the processing circuit, cause the processing circuit to:
perform an initial ordinary least-squares procedure to generate initial DPD coefficients,
wherein the performing of the modified least-squares operation further comprises iteratively scaling one or more of the initial DPD coefficients that exceed the amplitude upper bound.

20. The device of claim 17, wherein the performing of the modified least-squares operation further comprises determining a largest coefficient among initial coefficients of obtained from an initial ordinary least-squares procedure.
